(19) United States
(12) Patent Application Publication
(10) Pub. No.: US 2019/0382000 A1
(43) Pub. Date: Dec. 19, 2019

(54) APPARATUS AND METHOD FOR AUTOMATIC DRIVING

(71) Applicant: LG Electronics Inc., Seoul (KR)

(72) Inventor: Kibong SONG, Seoul (KR)

(21) Appl. No.: 16/552,448

(22) Filed: Aug. 27, 2019

(30) Foreign Application Priority Data
Jun. 21, 2019 (KR) 10-2019-0074225

(51) Int. Cl. B60W 30/02; G05D 1/00; B60W 40/08

(52) U.S. Cl. CPC B60W 30/025; G05D 2201/0213; B60W 40/08; G05D 1/0088

(57) ABSTRACT

An autonomous driving method includes: inferring a condition of a passenger based on sensor information about the passenger received from a sensor of the vehicle; receiving external environment information of the vehicle from the sensor of the vehicle; controlling the vehicle to allow the internal environment of the vehicle to be adjusted, based on the condition of the passenger and the external environment information determining whether there is a change in the inferred condition of the passenger, after the internal environment of the vehicle is adjusted; and controlling the vehicle to allow the internal environment of the vehicle to be readjusted, based on the determined results, the adjusted internal environment information of the vehicle, and the external environment information.

### CROSS-REFERENCE TO RELATED APPLICATION

This application is based on and claims priority under 35 U.S.C. § 119(a) to Korean Patent Application No. 10-2019-0074225, which was filed on Jun. 21, 2019, in the Korean Intellectual Property Office, the disclosure of which is incorporated herein in its entirety by reference.

### BACKGROUND

### 1. Field

The present disclosure relates to an autonomous driving apparatus and method of adjusting an internal environment of a vehicle based on a condition of a passenger and external environment information of the vehicle.

### 2. Description of the Related Art

An autonomous driving vehicle refers to a vehicle on which an autonomous driving apparatus capable of recognizing an environment around the vehicle and a condition of the vehicle, and thus controlling the driving of the vehicle is mounted. Meanwhile, in order to improve the convenience of the passenger of the vehicle as a sensing technology develops, there are being carried out various researches on the technology in which the autonomous driving vehicle monitors the condition of the passenger through a sensor and controls a configuration included in the vehicle according to the monitored results.

However, controlling the configuration of the vehicle by monitoring only the condition of the passenger of the vehicle means excluding consideration of other factors affecting the internal environment of the vehicle, which may limit the improvement of the convenience of the passenger of the vehicle.

### SUMMARY

The disclosed embodiments are intended to disclose an autonomous driving apparatus and method of adjusting an internal environment of a vehicle based on a condition of the passenger and external environment information of the vehicle. Technical problems to be dealt with by the present embodiment are not limited to the aforementioned technical problems, and other technical problems may be inferred from the following embodiments.

According to an embodiment of the present invention, there is provided an autonomous driving method, including: inferring a condition of a passenger based on sensor information about the passenger received from a sensor of the vehicle; receiving external environment information of the vehicle from the sensor of the vehicle; controlling the vehicle to allow the internal environment of the vehicle to be adjusted, based on the condition of the passenger and the external environment information; determining whether there is a change in the inferred condition of the passenger, after the internal environment of the vehicle is adjusted; and controlling the vehicle to allow the internal environment of the vehicle to be readjusted, based on the determined results, the adjusted internal environment information of the vehicle, and the external environment information.

According to another embodiment of the present invention, there is provided an autonomous driving apparatus, including: a processor configured to infer a condition of a passenger based on sensor information about the passenger received from a sensor of the vehicle, to receive external environment information of the vehicle from the sensor of the vehicle, to control the vehicle to allow the internal environment of the vehicle to be adjusted, based on the condition of the passenger and the external environment information, to determine whether there is a change in the inferred condition of the passenger after the internal environment of the vehicle is adjusted, and to control the vehicle to allow the internal environment of the vehicle to be readjusted based on the determined results, the adjusted internal environment information of the vehicle, and the external environment information; and a memory configured to store the external environment information of the vehicle, the condition of the passenger, and the adjusted internal environment information of the vehicle.

The specific matters of other embodiments are included in the detailed description and drawings.

According to an embodiment of the present invention, there are one or more of the following effects.

First, there is an effect that, since the internal environment of the vehicle is adjusted in consideration of not only the condition of the passenger of the vehicle but also the external environment of the vehicle, it is possible to provide the passenger with a suitable internal environment according to the external environment.

Second, there is another effect that, since the autonomous driving apparatus readjusts the internal environment based on a change in the condition of the passenger after adjusting the internal environment of the vehicle, it is possible to provide the passenger with a more suitable internal environment of the vehicle.

Third, there are further still other effects that, since the autonomous driving apparatus according to an embodiment stores contents on the adjustment of the internal environment of the vehicle corresponding to each passenger and adjusts the internal environment of the vehicle based on the stored contents, it is possible to provide personalized internal environments for respective passengers of the vehicle.

Fourth, there are still other effects that, since the autonomous driving apparatus according to another embodiment infers the internal environment of the vehicle, which is changed according to driving, based on data stored in advance, and adjusts the internal environment of the vehicle, it is possible to further improve the convenience of the passenger.

The effects of the invention are not limited to the aforementioned effects, and other effects that have not been mentioned may be specifically understood by those skilled in the art from the description of the claims.

### BRIEF DESCRIPTION OF THE DRAWINGS

The above and other aspects, features, and advantages of certain embodiments will be more apparent from the following detailed description taken in conjunction with the accompanying drawings, in which:

FIG. 1 illustrates an AI device 100 according to an embodiment of the present disclosure.

FIG. 2 illustrates AI server 200 according to an embodiment of the present disclosure.

FIG. 3 illustrates an AI system 1 according to an embodiment of the present disclosure.

FIG. 4 is a view illustrating an example of adjusting an internal environment of a vehicle based on a condition of a passenger and external environment information of a vehicle, according to an embodiment of the present invention.

FIG. 5 is a view illustrating an example in which, after the internal environment of the vehicle is adjusted, the inferred condition of the passenger is changed in a manner opposite to a condition before the adjustment of the internal environment of the vehicle, according to an embodiment of the present invention.

FIG. 6 is a view illustrating an example in which, after the internal environment of the vehicle is adjusted, the inferred condition of the passenger is maintained in the condition before the adjustment of the internal environment of the vehicle or changed in a serious direction, according to an embodiment of the present invention.

FIG. 7 is a view illustrating an example in which an autonomous driving apparatus proposes to adjust an internal environment of a vehicle to a passenger based on the external environment of the vehicle, according to another embodiment of the present invention.

FIG. 8 is a view illustrating a mapping table according to an embodiment of the present invention.

FIG. 9 is a view illustrating an example in which the internal environment of a vehicle is adjusted, in a case where a predicted driving route of the vehicle is received according to an embodiment of the present invention.

FIG. 10 is a block diagram of an autonomous driving apparatus according to an embodiment of the present invention.

FIG. 11 is a flowchart of a method of adjusting the internal environment of a vehicle, according to an embodiment of the present invention.

FIG. 12 is a flowchart of a method of adjusting an internal environment of a vehicle, according to another embodiment of the present invention.

FIG. 13 is a flowchart of a method of adjusting the internal environment of a vehicle, according to another embodiment of the present invention.

### DETAILED DESCRIPTION

In the following detailed description, reference is made to the accompanying drawing, which form a part hereof. The illustrative embodiments described in the detailed description, drawing, and claims are not meant to be limiting. Other embodiments may be utilized, and other changes may be made, without departing from the spirit or scope of the subject matter presented here.

Exemplary embodiments of the present invention are described in detail with reference to the accompanying drawings. Detailed descriptions of technical specifications well-known in the art and unrelated directly to the present invention may be omitted to avoid obscuring the subject matter of the present invention. This aims to omit unnecessary description so as to make clear the subject matter of the present invention. For the same reason, some elements are exaggerated, omitted, or simplified in the drawings and, in practice, the elements may have sizes and/or shapes different from those shown in the drawings. Throughout the drawings, the same or equivalent parts are indicated by the same reference numbers. Advantages and features of the present invention and methods of accomplishing the same may be understood more readily by reference to the following detailed description of exemplary embodiments and the accompanying drawings. The present invention may, however, be embodied in many different forms and should not be construed as being limited to the exemplary embodiments set forth herein. Rather, these exemplary embodiments are provided so that this disclosure will be thorough and complete and will fully convey the concept of the invention to those skilled in the art, and the present invention will only be defined by the appended claims. Like reference numerals refer to like elements throughout the specification. It will be understood that each block of the flowcharts and/or block diagrams, and combinations of blocks in the flowcharts and/or block diagrams, can be implemented by computer program instructions. These computer program instructions may be provided to a processor of a general-purpose computer, special purpose computer, or other programmable data processing apparatus, such that the instructions which are executed via the processor of the computer or other programmable data processing apparatus create means for implementing the functions/acts specified in the flowcharts and/or block diagrams. These computer program instructions may also be stored in a non-transitory computer-readable memory that can direct a computer or other programmable data processing apparatus to function in a particular manner, such that the instructions stored in the non-transitory computer-readable memory produce articles of manufacture embedding instruction means which implement the function/act specified in the flowcharts and/or block diagrams. The computer program instructions may also be loaded onto a computer or other programmable data processing apparatus to cause a series of operational steps to be performed on the computer or other programmable apparatus to produce a computer implemented process such that the instructions which are executed on the computer or other programmable apparatus provide steps for implementing the functions/acts specified in the flowcharts and/or block diagrams. Furthermore, the respective block diagrams may illustrate parts of modules, segments, or codes including at least one or more executable instructions for performing specific logic function(s). Moreover, it should be noted that the functions of the blocks may be performed in a different order in several modifications. For example, two successive blocks may be performed substantially at the same time, or may be performed in reverse order according to their functions. According to various embodiments of the present disclosure, the term “module”, means, but is not limited to, a software or hardware component, such as a Field Programmable Gate Array (FPGA) or Application Specific Integrated Circuit (ASIC), which performs certain tasks. A module may advantageously be configured to reside on the addressable storage medium and be configured to be executed on one or more processors. Thus, a module may include, by way of example, components, such as software components, object-oriented software components, class components and task components, processes, functions, attributes, procedures, subroutines, segments of program code, drivers, firmware, microcode, circuitry, data, databases, data structures, tables, arrays, and variables. The functionality provided for in the components and modules may be combined into fewer components and modules or further separated into additional components and modules. In addition, the components and modules may be implemented such that they execute one or more CPUs in a device or a secure multimedia card. In addition, a controller mentioned in the embodiments may include at least one processor that is operated to control a corresponding apparatus.

Artificial Intelligence refers to the field of studying artificial intelligence or a methodology capable of making the artificial intelligence. Machine learning refers to the field of studying methodologies that define and solve various problems handled in the field of artificial intelligence. Machine learning is also defined as an algorithm that enhances the performance of a task through a steady experience with respect to the task.

An artificial neural network (ANN) is a model used in machine learning, and may refer to a general model that is composed of artificial neurons (nodes) forming a network by synaptic connection and has problem solving ability. The artificial neural network may be defined by a connection pattern between neurons of different layers, a learning process of updating model parameters, and an activation function of generating an output value.

The artificial neural network may include an input layer and an output layer, and may selectively include one or more hidden layers. Each layer may include one or more neurons, and the artificial neural network may include a synapse that interconnects neurons. In the artificial neural network, each neuron may output input signals that are input through the synapse, weights, and the value of an activation function concerning deflection.

Model parameters refer to parameters determined by learning, and include weights for synaptic connection and deflection of neurons, for example. Then, hyper-parameters mean parameters to be set before learning in a machine learning algorithm, and include a learning rate, the number of repetitions, the size of a mini-batch, and an initialization function, for example.

It can be said that the purpose of learning of the artificial neural network is to determine a model parameter that minimizes a loss function. The loss function maybe used as an index for determining an optimal model parameter in a learning process of the artificial neural network.

Machine learning may be classified, according to a learning method, into supervised learning, unsupervised learning, and reinforcement learning.

The supervised learning refers to a learning method for an artificial neural network in the state in which a label for learning data is given. The label may refer to a correct answer (or a result value) to be deduced by an artificial neural network when learning data is input to the artificial neural network. The unsupervised learning may refer to a learning method for an artificial neural network in the state in which no label for learning data is given. The reinforcement learning may mean a learning method in which an agent defined in a certain environment learns to select a behavior or a behavior sequence that maximizes cumulative compensation in each state.

Machine learning realized by a deep neural network (DNN) including multiple hidden layers among artificial neural networks is also called deep learning, and deep learning is a part of machine learning. Hereinafter, machine learning is used as a meaning including deep learning.

The term “autonomous driving” refers to a technology of autonomous driving, and the term “autonomous vehicle” refers to a vehicle that travels without a user's operation or with a user's minimum operation.

For example, autonomous driving may include all of a technology of maintaining the lane in which a vehicle is driving, a technology of automatically adjusting a vehicle speed such as adaptive cruise control, a technology of causing a vehicle to automatically drive along a given route, and a technology of automatically setting a route, along which a vehicle drives, when a destination is set.

A vehicle may include all of a vehicle having only an internal combustion engine, a hybrid vehicle having both an internal combustion engine and an electric motor, and an electric vehicle having only an electric motor, and may be meant to include not only an automobile but also a train and a motorcycle, for example.

At this time, an autonomous vehicle may be seen as a robot having an autonomous driving function.

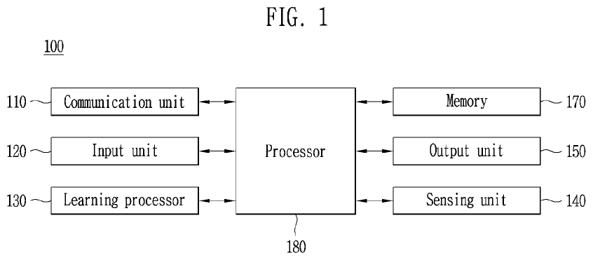

FIG. 1 illustrates an AI device 100 according to an embodiment of the present disclosure.

AI device 100 may be realized into, for example, a stationary appliance or a movable appliance, such as a TV, a projector, a cellular phone, a smart phone, a desktop computer, a laptop computer, a digital broadcasting terminal, a personal digital assistant (PDA), a portable multimedia player (PMP), a navigation system, a tablet PC, a wearable device, a set-top box (STB), a DMB receiver, a radio, a washing machine, a refrigerator, a digital signage, a robot, or a vehicle.

Referring to FIG. 1, Terminal 100 may include a communication unit 110, an input unit 120, a learning processor 130, a sensing unit 140, an output unit 150, a memory 170, and a processor 180, for example.

Communication unit 110 may transmit and receive data to and from external devices, such as other AI devices 100a to 100e and an AI server 200, using wired/wireless communication technologies. For example, communication unit 110 may transmit and receive sensor information, user input, learning models, and control signals, for example, to and from external devices.

At this time, the communication technology used by communication unit 110 may be, for example, a global system for mobile communication (GSM), code division multiple Access (CDMA), long term evolution (LTE), 5G, wireless LAN (WLAN), wireless-fidelity (Wi-Fi), Bluetooth™, radio frequency identification (RFID), infrared data association (IrDA), ZigBee, or near field communication (NFC).

Input unit 120 may acquire various types of data.

At this time, input unit 120 may include a camera for the input of an image signal, a microphone for receiving an audio signal, and a user input unit for receiving information input by a user, for example. Here, the camera or the microphone may be handled as a sensor, and a signal acquired from the camera or the microphone may be referred to as sensing data or sensor information.

Input unit 120 may acquire, for example, input data to be used when acquiring an output using learning data for model learning and a learning model. Input unit 120 may acquire unprocessed input data, and in this case, processor 180 or learning processor 130 may extract an input feature as pre-processing for the input data.

Learning processor 130 may cause a model configured with an artificial neural network to learn using the learning data. Here, the learned artificial neural network may be called a learning model. The learning model may be used to deduce a result value for newly input data other than the learning data, and the deduced value may be used as a determination base for performing any operation.

At this time, learning processor 130 may perform AI processing along with a learning processor 240 of AI server 200.

At this time, learning processor 130 may include a memory integrated or embodied in AI device 100. Alternatively, learning processor 130 may be realized using memory 170, an external memory directly coupled to AI device 100, or a memory held in an external device.

Sensing unit 140 may acquire at least one of internal information of AI device 100 and surrounding environmental information and user information of AI device 100 using various sensors.

At this time, the sensors included in sensing unit 140 may be a proximity sensor, an illuminance sensor, an acceleration sensor, a magnetic sensor, a gyro sensor, an inertial sensor, an RGB sensor, an IR sensor, a fingerprint recognition sensor, an ultrasonic sensor, an optical sensor, a microphone, a lidar, and a radar, for example.

Output unit 150 may generate, for example, a visual output, an auditory output, or a tactile output.

At this time, output unit 150 may include, for example, a display that outputs visual information, a speaker that outputs auditory information, and a haptic module that outputs tactile information.

Memory 170 may store data which assists various functions of AI device 100. For example, memory 170 may store input data acquired by input unit 120, learning data, learning models, and learning history, for example.

Processor 180 may determine at least one executable operation of AI device 100 based on information determined or generated using a data analysis algorithm or a machine learning algorithm. Then, processor 180 may control constituent elements of AI device 100 to perform the determined operation.

To this end, processor 180 may request, search, receive, or utilize data of learning processor 130 or memory 170, and may control the constituent elements of AI device 100 so as to execute a predictable operation or an operation that is deemed desirable among the at least one executable operation.

At this time, when connection of an external device is necessary to perform the determined operation, processor 180 may generate a control signal for controlling the external device and may transmit the generated control signal to the external device.

Processor 180 may acquire intention information with respect to user input and may determine a user request based on the acquired intention information.

At this time, processor 180 may acquire intention information corresponding to the user input using at least one of a speech to text (STT) engine for converting voice input into a character string and a natural language processing (NLP) engine for acquiring natural language intention information.

At this time, at least a part of the STT engine and/or the NLP engine may be configured with an artificial neural network learned according to a machine learning algorithm. Then, the STT engine and/or the NLP engine may have learned by learning processor 130, may have learned by learning processor 240 of AI server 200, or may have learned by distributed processing of processors 130 and 240.

Processor 180 may collect history information including, for example, the content of an operation of AI device 100 or feedback of the user with respect to an operation, and may store the collected information in memory 170 or learning processor 130, or may transmit the collected information to an external device such as AI server 200. The collected history information may be used to update a learning model.

Processor 180 may control at least some of the constituent elements of AI device 100 in order to drive an application program stored in memory 170. Moreover, processor 180 may combine and operate two or more of the constituent elements of AI device 100 for the driving of the application program.

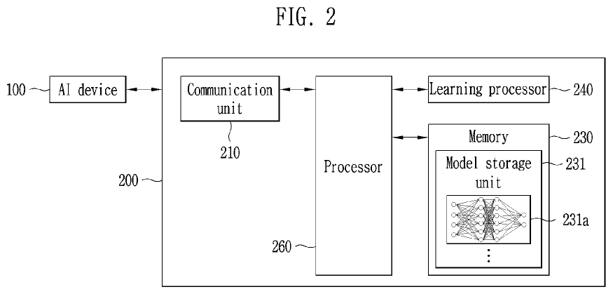

FIG. 2 illustrates AI server 200 according to an embodiment of the present disclosure.

Referring to FIG. 2, AI server 200 may refer to a device that causes an artificial neural network to learn using a machine learning algorithm or uses the learned artificial neural network. Here, AI server 200 may be constituted of multiple servers to perform distributed processing, and may be defined as a 5G network. At this time, AI server 200 may be included as a constituent element of AI device 100 so as to perform at least a part of AI processing together with AI device 100.

AI server 200 may include a communication unit 210, a memory 230, a learning processor 240, and a processor 260, for example.

Communication unit 210 may transmit and receive data to and from an external device such as AI device 100.

Memory 230 may include a model storage unit 231. Model storage unit 231 may store a model (or an artificial neural network) 231a which is learning or has learned via learning processor 240.

Learning processor 240 may cause artificial neural network 231a to learn learning data. A learning model may be used in the state of being mounted in AI server 200 of the artificial neural network, or may be used in the state of being mounted in an external device such as AI device 100.

The learning model may be realized in hardware, software, or a combination of hardware and software. In the case in which a part or the entirety of the learning model is realized in software, one or more instructions constituting the learning model may be stored in memory 230.

Processor 260 may deduce a result value for newly input data using the learning model, and may generate a response or a control instruction based on the deduced result value.

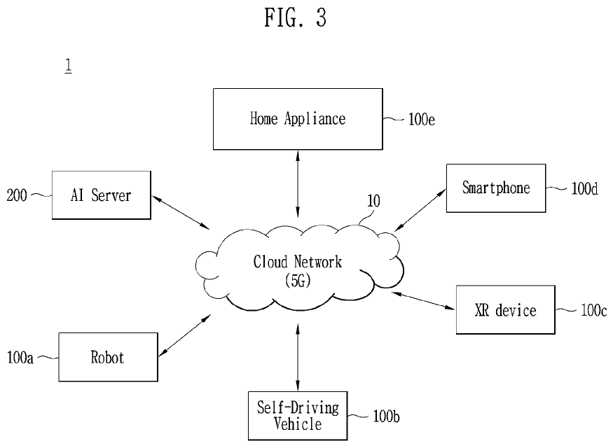

FIG. 3 illustrates an AI system 1 according to an embodiment of the present disclosure.

Referring to FIG. 3, in AI system 1, at least one of AI server 200, a robot 100a, an autonomous driving vehicle 100b, an XR device 100c, a smart phone 100d, and a home appliance 100e is connected to a cloud network 10. Here, robot 100a, autonomous driving vehicle 100b, XR device 100c, smart phone 100d, and home appliance 100e, to which AI technologies are applied, may be referred to as AI devices 100a to 100e.

Cloud network 10 may constitute a part of a cloud computing infra-structure, or may mean a network present in the cloud computing infra-structure. Here, cloud network 10 may be configured using a 3G network, a 4G or long term evolution (LTE) network, or a 5G network, for example.

That is, respective devices 100a to 100e and 200 constituting AI system 1 may be connected to each other via cloud network 10. In particular, respective devices 100a to 100e and 200 may communicate with each other via a base station, or may perform direct communication without the base station.

AI server 200 may include a server which performs AI processing and a server which performs an operation with respect to big data.

AI server 200 may be connected to at least one of robot 100a, autonomous driving vehicle 100b, XR device 100c, smart phone 100d, and home appliance 100e, which are AI devices constituting AI system 1, via cloud network 10, and may assist at least a part of AI processing of connected AI devices 100a to 100e.

At this time, instead of AI devices 100a to 100e, AI server 200 may cause an artificial neural network to learn according to a machine learning algorithm, and may directly store a learning model or may transmit the learning model to AI devices 100a to 100e.

At this time, AI server 200 may receive input data from AI devices 100a to 100e, may deduce a result value for the received input data using the learning model, and may generate a response or a control instruction based on the deduced result value to transmit the response or the control instruction to AI devices 100a to 100e.

Alternatively, AI devices 100a to 100e may directly deduce a result value with respect to input data using the learning model, and may generate a response or a control instruction based on the deduced result value.

Hereinafter, various embodiments of AI devices 100a to 100e, to which the above-described technology is applied, will be described. Here, AI devices 100a to 100e illustrated in FIG. 3 may be specific embodiments of AI device 100 illustrated in FIG. 1.

Autonomous driving vehicle 100b may be realized into a mobile robot, a vehicle, or an unmanned air vehicle, for example, through the application of AI technologies.

Autonomous driving vehicle 100b may include an autonomous driving control module for controlling an autonomous driving function, and the autonomous driving control module may mean a software module or a chip realized in hardware. The autonomous driving control module may be a constituent element included in autonomous driving vehicle 100b, but may be a separate hardware element outside autonomous driving vehicle 100b so as to be connected to autonomous driving vehicle 100b.

Autonomous driving vehicle 100b may acquire information on the state of autonomous driving vehicle 100b using sensor information acquired from various types of sensors, may detect (recognize) the surrounding environment and an object, may generate map data, may determine a movement route and a driving plan, or may determine an operation.

Here, autonomous driving vehicle 100b may use sensor information acquired from at least one sensor among a lidar, a radar, and a camera in the same manner as robot 100a in order to determine a movement route and a driving plan.

In particular, autonomous driving vehicle 100b may recognize the environment or an object with respect to an area outside the field of vision or an area located at a predetermined distance or more by receiving sensor information from external devices, or may directly receive recognized information from external devices.

Autonomous driving vehicle 100b may perform the above-described operations using a learning model configured with at least one artificial neural network. For example, autonomous driving vehicle 100b may recognize the surrounding environment and the object using the learning model, and may determine a driving line using the recognized surrounding environment information or object information. Here, the learning model may be directly learned in autonomous driving vehicle 100b, or may be learned in an external device such as AI server 200.

At this time, autonomous driving vehicle 100b may generate a result using the learning model to perform an operation, but may transmit sensor information to an external device such as AI server 200 and receive a result generated by the external device to perform an operation.

Autonomous driving vehicle 100b may determine a movement route and a driving plan using at least one of map data, object information detected from sensor information, and object information acquired from an external device, and a drive unit may be controlled to drive autonomous driving vehicle 100b according to the determined movement route and driving plan.

The map data may include object identification information for various objects arranged in a space (e.g., a road) along which autonomous driving vehicle 100b drives. For example, the map data may include object identification information for stationary objects, such as streetlights, rocks, and buildings, and movable objects such as vehicles and pedestrians. Then, the object identification information may include names, types, distances, and locations, for example.

In addition, autonomous driving vehicle 100b may perform an operation or may drive by controlling the drive unit based on user control or interaction. At this time, autonomous driving vehicle 100b may acquire interactional intention information depending on a user operation or voice expression, and may determine a response based on the acquired intention information to perform an operation.

The autonomous driving vehicle according to the present invention may adjust the internal environment of the vehicle based on the condition of the passenger and the external environment of the vehicle.

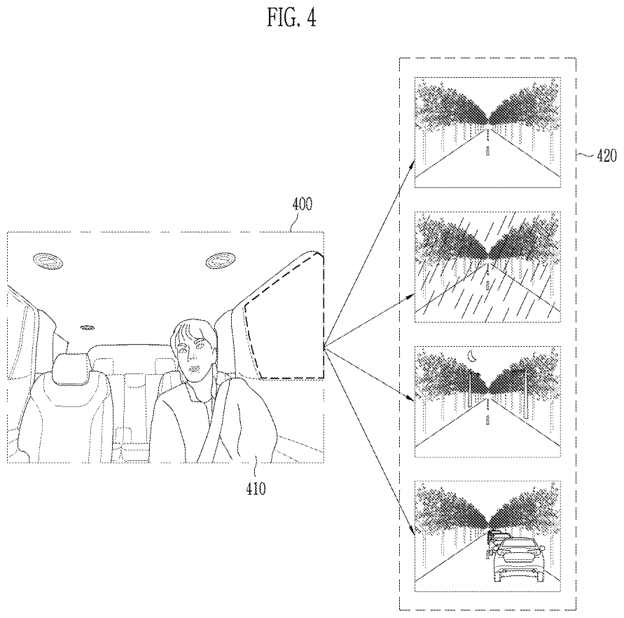

FIG. 4 is a view illustrating an example of adjusting an internal environment of a vehicle based on a condition of a passenger and external environment information of a vehicle, according to an embodiment of the present invention.

With reference to FIG. 4, the autonomous driving apparatus may receive sensor information about a passenger 410 of a vehicle 400 through a sensor mounted on the vehicle 400, and infer the condition of the passenger 410 based on the sensor information. Specifically, the autonomous driving apparatus may receive sensor information about the facial expression, body temperature, gesture, seating posture, and the like of the passenger 410 from the sensor of the vehicle 400, and infer the condition of the passenger 410 according to the sensor information. Here, the inferred condition of the passenger 410 is defined as an abnormal manifestation appearing on a passenger 410 when a passenger 410 is uncomfortable as much as the adjustment of the internal environment of the vehicle 400 is needed.

For example, in a case where the autonomous driving apparatus receives sensor information about an increase in the body temperature of the passenger 410 and a gesture in which the passenger 410 waves a hand, the autonomous driving apparatus infers a condition under which the passenger 410 is angry or irritated, based on the received sensor information. In addition, the autonomous driving apparatus may control the vehicle 400 to allow the internal temperature of the vehicle to be lowered, based on the inferred condition of the passenger 410. In addition, in a case where the autonomous driving apparatus receives sensor information about the seating posture and the facial expression of the passenger 410, the autonomous driving apparatus may infer that the passenger 410 is asleep, based on the received sensor information.

In a case where it is inferred that the passenger 410 is angry or irritated, the autonomous driving apparatus may control the vehicle 400 to allow the internal temperature of the vehicle 400 to be lowered. At this time, the autonomous driving apparatus according to an embodiment of the present invention may adjust the internal environment of the vehicle 400 by further considering an external environment 420 of the vehicle 400. Here, the external environment 420 of the vehicle 400 may be defined as an environment including night and day, weather, a type of the road (a tunnel, an urban road, a coastal road, and the like) on which the vehicle 400 is currently driving, a degree of congestion on the road where the vehicle is driving, a temperature, humidity, a degree of fine dust, and the like. However, the external environment 420 of the vehicle 400 which the autonomous driving apparatus may consider is not limited thereto.

For example, in a case where the autonomous driving apparatus needs to control the vehicle 400 to allow an internal temperature of the vehicle to be lowered based on the inferred condition of the passenger 410, the autonomous driving apparatus may consider the external environment of the vehicle 400. For example, when an external temperature of the vehicle 400 is higher than the internal temperature thereof or it's raining, the autonomous driving apparatus may control the vehicle 400 to allow an air conditioner mounted on the vehicle 400 to be operated, instead of opening a window of the vehicle 400. In addition, even in a case where there is serious congestion on the road where the vehicle 400 is driving, the autonomous driving apparatus may control the vehicle 400 to allow the air conditioner of the vehicle 400 to be operated. On the other hand, when the external temperature of the vehicle 400 is lower than the internal temperature thereof or it is night, the autonomous driving apparatus may control the vehicle 400 to allow the window of the vehicle 400 to be opened, instead of operating the air conditioner of the vehicle 400.

Meanwhile, in order to adjust the internal environment of the vehicle 400, an autonomous driving apparatus according to an embodiment of the present invention may control a heater, an air conditioner, a humidifier, a dehumidifier, a lighting device, a seat, a sound device, an aroma spreading device and the like of the vehicle 400. However, the components of the vehicle 400 which the autonomous driving apparatus may adjust according to the condition of the passenger 410 and the external environment 420 of the vehicle 400 are not limited thereto.

In addition, in a case where, after the internal environment of the vehicle is adjusted, the autonomous driving apparatus according to an embodiment of the present invention determines that the inferred condition of the passenger is changed in a relaxed direction from the condition before the adjustment of the internal environment of the vehicle, the autonomous driving apparatus may control the vehicle to allow a degree of the readjustment of the internal environment of the vehicle to be lower than a degree of the adjustment of the internal environment of the vehicle.

For example, in a case where, in order to lower the internal temperature of the vehicle 400, the autonomous driving apparatus adjusts the internal environment of the vehicle 400 to allow the air conditioner of the vehicle 400 to be operated based on the inferred condition of the passenger 410 and the external environment 420 of the vehicle 400, the body temperature of the passenger may decrease.

In this case, the autonomous driving apparatus determines that the condition of the passenger 410 is changed in a relaxed direction from the condition before the adjustment of the internal environment of the vehicle 400, and may readjust the internal environment of the vehicle 400 to a degree that is lower than a degree of the adjustment of the internal environment of the vehicle 400. That is, in the example, the autonomous driving apparatus may control the vehicle 400 to allow the operation of the air conditioner of the vehicle 400 to be stopped or the set temperature to be higher.

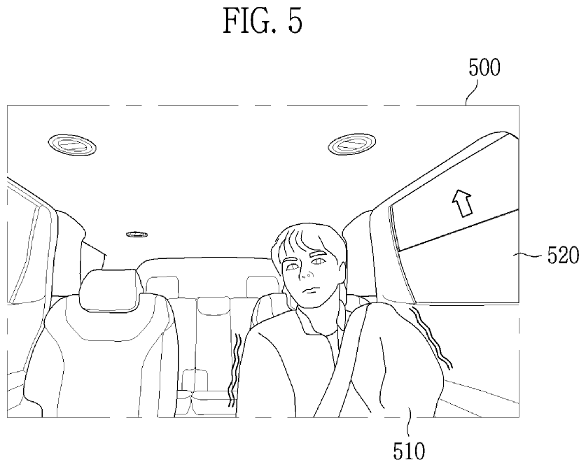

FIG. 5 is a view illustrating an example in which, after the internal environment of the vehicle is adjusted, the inferred condition of the passenger is changed in a manner opposite to a condition before the adjustment of the internal environment of the vehicle, according to an embodiment of the present invention.

In a case where, after the internal environment of the vehicle is adjusted, the autonomous driving apparatus according to an embodiment of the present invention determines that the inferred condition of the passenger is changed in a manner opposite to the condition before the adjustment of the internal environment of the vehicle, a readjustment of the internal environment of the vehicle may be an adjustment for attenuating the adjustment of the internal environment of the vehicle.

For example, as illustrated in FIG. 4, when it is inferred as the condition of the passenger 410 that the passenger has an increase in the body temperature of the passenger 410, and the external temperature of the vehicle 400 is lower than the internal temperature thereof, the autonomous driving apparatus may control the vehicle to allow the window of the vehicle 400 to be opened, in order to lower the internal temperature of the vehicle 400.

At this time, the autonomous driving apparatus according to an embodiment of the present invention may continue to infer a condition of the passenger 510 even after the internal environment of the vehicle 500 is adjusted, and determine whether there is a change in the inferred condition of the passenger 510.

With reference to FIG. 5, in a case where, after the internal environment of the vehicle 500 is adjusted, it is inferred as the condition of the passenger 510 that the passenger has a decrease in the body temperature of the passenger or the passenger shivers with cold, the autonomous driving apparatus may determine that the condition of the passenger 510 is changed in a manner opposite to the condition before the adjustment of the internal environment of the vehicle 500. In such a case, in order to attenuate the adjustment of the internal environment of the vehicle 500, that is, to increase the internal temperature of the vehicle 500 in the example of FIG. 5, the autonomous driving apparatus may control the vehicle 500 to raise the window 520.

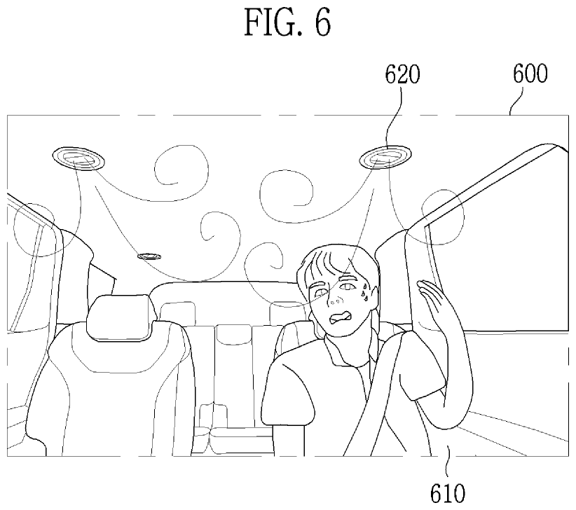

FIG. 6 is a view illustrating an example in which, after the internal environment of the vehicle is adjusted, the inferred condition of the passenger is maintained in the condition before the adjustment of the internal environment of the vehicle or changed in a serious direction, according to an embodiment of the present invention.

In a case where, after the internal environment of the vehicle is adjusted, the autonomous driving apparatus according to an embodiment of the present invention determines that the inferred condition of the passenger is maintained in the condition before the adjustment of the internal environment of the vehicle or changed in a serious direction, the autonomous driving apparatus may perform a readjustment of the internal environment of the vehicle to a degree that is higher than the degree of the adjustment of the internal environment of the vehicle.

For example, as illustrated in FIG. 4, even after, in order to lower the internal temperature of the vehicle 400, the autonomous driving apparatus adjusts the internal environment of the vehicle 400 to allow the air conditioner of the vehicle 400 to be operated, the body temperature of the passenger may be maintained.

With reference to FIG. 6, in a case where the body temperature of a passenger 610 is maintained or sweating, or waves a hand, even though the internal environment of the vehicle 600 is adjusted, the autonomous driving apparatus may determine that the condition of the passenger 610 is maintained in the condition before the adjustment of the internal environment of the vehicle 600 or changed in a serious direction. In such a case, the autonomous driving apparatus may readjust the internal environment of the vehicle 600 to a degree that is higher than a degree of the adjustment of the internal environment of the vehicle. That is, with reference to FIG. 6, the autonomous driving apparatus may control the vehicle 600 to allow the air conditioner 620 of the vehicle 600 to be operated harder.

Meanwhile, FIGS. 4 to 6 illustrate an embodiment in which sensor information about a passenger is acquired through a camera mounted on an autonomous driving vehicle, but the number of sensors for acquiring sensor information about the passenger and types of sensors is not limited thereto. For example, the autonomous driving apparatus may receive sensor information that the body temperature of the passenger is increased through the temperature sensor of the vehicle, and thus may control the vehicle to allow the internal environment of the vehicle to be adjusted. The autonomous driving apparatus may receive sensor information about a snoring sound of the passenger and infer that the passenger is asleep, and thus may control the vehicle to allow the internal environment of the vehicle of to be adjusted.

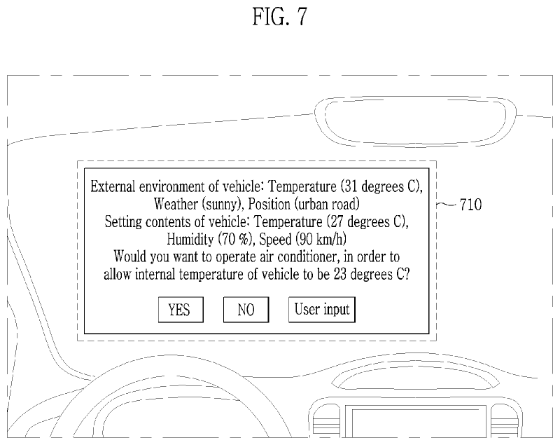

FIG. 7 is a view illustrating an example in which an autonomous driving apparatus proposes to adjust an internal environment of a vehicle to a passenger based on the external environment of the vehicle, according to another embodiment of the present invention.

The autonomous driving apparatus according to an embodiment of the present invention may output a message proposing to adjust the internal environment of the vehicle based on the external environment of the vehicle and the inferred condition of the passenger.

With reference to FIG. 7, the autonomous driving apparatus may output a message 710 including external environment information of a vehicle, setting contents of the current internal environment of the vehicle, and a method of adjusting the internal environment of the vehicle. In addition, the autonomous driving apparatus may receive an input of the passenger through the message 710. In a case where the input of the passenger is received, the autonomous driving apparatus may adjust the internal environment of the vehicle based on the input of the received passenger.

Meanwhile, in FIG. 7, the message 710 indicates that external environment information of the vehicle, setting contents of the current internal environment of the vehicle, and a method of adjusting the internal environment of the vehicle are provided to the passenger at the same time. However, it is obvious to those skilled in the art that such information may be sequentially provided to the passenger.

In addition, FIG. 7 illustrates that external environment information, setting contents of the current internal environment of the vehicle and a method of adjusting the internal environment of the vehicle is displayed on a head-up display (HUD) in the form of a message, but a displayed location of the message is not limited thereto. It is obvious to those skilled in the art that the message may be not only displayed in one area of the vehicle but also output in the form of a voice signal.

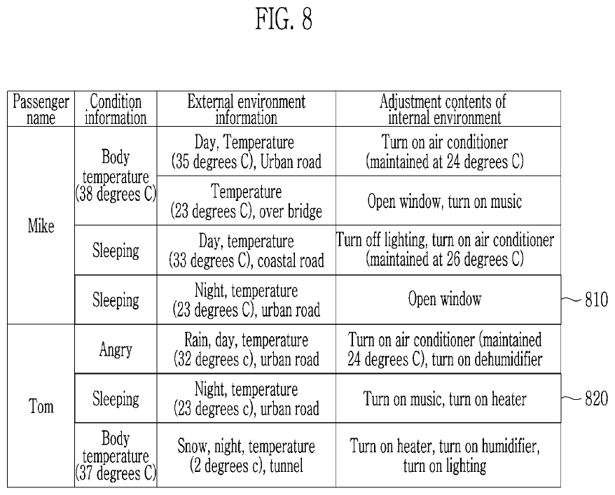

FIG. 8 is a view illustrating a mapping table according to an embodiment of the present invention.

The autonomous driving apparatus according to an embodiment of the present invention may store a mapping table in which a condition of the passenger, external environment information of the vehicle, and contents on the adjustment of the internal environment are mapped.

In a case where the mapping table is stored in the autonomous driving apparatus as illustrated in FIG. 8, without calculating an adjustment of the internal environment of the vehicle every time, the autonomous driving apparatus may check how an internal environment of the vehicle has been adjusted in a condition of a similar passenger and the external environment based on the mapping table and thus may adjust the internal environment of the vehicle. Therefore, it is possible to reduce the complexity of the autonomous driving apparatus and provide the passenger with a more suitable internal environment.

In addition, the autonomous driving apparatus according to an embodiment of the present invention may store the mapping table for each passenger.

With reference to FIG. 8, different internal environments 810 and 820 may be provided according to passengers (Mike and Tom), respectively, in the same condition and external environment. In a case where the internal environment of the vehicle is adjusted based on a signal input by the passenger, internal environments of the vehicle provided for respective passengers may be different from one another.

In this case, there is an effect that, since the autonomous driving apparatus may provide the internal environment of the preferred vehicle for each passenger, it is possible to provide personalized internal environments of for respective users of the vehicle.

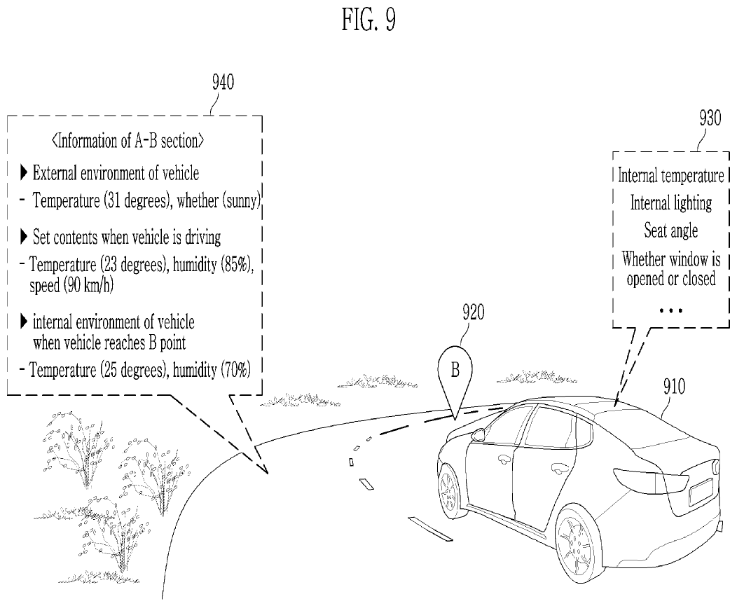

FIG. 9 is a view illustrating an example in which the internal environment of a vehicle is adjusted, in a case where a predicted driving route of the vehicle is received according to an embodiment of the present invention.

The autonomous driving apparatus according to an embodiment of the present invention may control the vehicle to allow the internal environment of the vehicle to be readjusted, based on at least one of a predicted driving route of the vehicle and a speed of the vehicle.

Specifically, in a case where both the predicted driving route of the vehicle and the speed of the vehicle are received, the autonomous driving apparatus may calculate estimated arrival time at which the vehicle reaches one point on the predicted driving route based on the speed of the vehicle, and control the vehicle to allow the internal environment of the vehicle to be adjusted, based on the estimated arrival time and environment information at the point.

In addition, in a case where the predicted driving route of the vehicle includes a driving route having a history in which the vehicle has been previously driven along the driving route, and information of the driving route along which the vehicle has been previously driven is stored in a memory, the autonomous driving apparatus may infer the internal environment of the vehicle when the vehicle reaches one point on the predicted driving route based on the information of the driving route, and control the vehicle based on the inferred internal environment. Here, the memory may be a component included in the autonomous driving apparatus, but the memory may be located at any position as long as the autonomous driving apparatus has access to information about one section.

In addition, a component for inferring the internal environment of the vehicle when the vehicle reaches one point is located outside the autonomous driving apparatus and may be configured to output the inferred results, in a case where data necessary for inference is input to the autonomous driving apparatus.

With reference to FIG. 9, the autonomous driving apparatus may receive the predicted driving route including a B point 920 and the speed information of the vehicle 910. In this case, the autonomous driving apparatus may calculate an estimated arrival time at which the vehicle reaches the B point 920 based on the speed of the vehicle 910, and distance information between the current position and the B point 920.

In addition, the autonomous driving apparatus may check whether there is a history of driving in an A-B section on the predicted driving route, and search for whether information 940 of the A-B section is stored in the memory, in a case where there is a history of driving. At this time, the information 940 of the A-B section stored in the memory includes external environment information of the vehicle, internal environment information of the vehicle 910 when the vehicle is driving, and change information in the internal environment information of a vehicle 900 when the vehicle reaches the B point 920, and so on.

In a case where the information 940 of the A-B section is stored in the memory, the autonomous driving apparatus may infer the internal environment of the vehicle 910 when the vehicle 910 reaches the B point 920, based on the internal environment information 930 of the current vehicle 910 and information 940 of the A-B section. In this way, based on the inferred information, the autonomous driving apparatus may control the vehicle 910 to allow the internal environment of the vehicle 910 to be adjusted.

That is, since the autonomous driving apparatus according to the embodiment of the present invention adjusts the internal environment of the vehicle based on not only the external environment information of the vehicle but also inferred matters of the internal environment of the vehicle at one point where the vehicle reaches during driving, there is an effect that it is possible to provide the passenger with a more suitable internal environment of the vehicle.

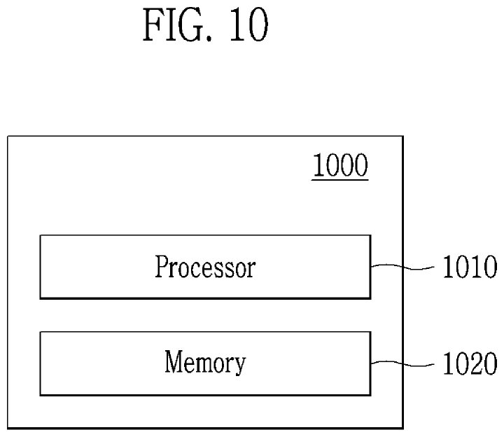

FIG. 10 is a block diagram of an autonomous driving apparatus according to an embodiment of the present invention.

An autonomous driving apparatus 1000 according to an embodiment of the present invention may include a processor 1010 and a memory 1020.

The processor 1010 may control components included in the vehicle. In addition, it is possible to infer a condition of a passenger based on sensor information about the passenger received from a sensor of the vehicle, to receive the external environment information of the vehicle from the sensor of the vehicle, to control the vehicle to allow the internal environment of the vehicle to be adjusted based on the condition of the passenger and external environment information, to determine whether there is a change in the inferred condition of the passenger after the internal environment of the vehicle is adjusted, and to control the vehicle to allow the internal environment of the vehicle to be readjusted based on the determined results, the adjusted internal environment information of the vehicle, and external environmental information.

In a case where it is determined after the internal environment of the vehicle has been adjusted that the inferred condition of the passenger is changed in a relaxed direction from the condition before the adjustment of the internal environment of the vehicle, the processor 1010 may control the vehicle to allow a degree of the readjustment of the internal environment of the vehicle to be lower than a degree of the adjustment of the internal environment of the vehicle.

In addition, in a case where it is determined after the internal environment of the vehicle is adjusted that the inferred condition of the passenger is changed in a manner opposite to the condition before the adjustment of the internal environment of the vehicle, the processor 1010 may control the vehicle to allow a readjustment of the internal environment of the vehicle to be an adjustment for attenuating the adjustment of the internal environment of the vehicle.

In a case where, after the internal environment of the vehicle is adjusted, it is determined that the inferred condition of the passenger is maintained in the condition before the adjustment of the internal environment of the vehicle or changed in a serious direction, the processor 1010 may control the vehicle to allow a degree of the readjustment of the internal environment of the vehicle to be higher than a degree of the adjustment of the internal environment of the vehicle.

In addition, the processor 1010 may control the vehicle to allow the internal environment of the vehicle to be adjusted, based on a signal input by the passenger. At this time, the autonomous driving apparatus may receive a signal from a passenger through a display included in the vehicle and may receive a signal from the passenger through a microphone included in the vehicle, but forms of a signal input by the passenger are not limited thereto.

In addition, the processor 1010 may control the vehicle to allow the internal environment of the vehicle to be readjusted, based on at least one of the predicted driving route of the vehicle and the speed of the vehicle. In this case, the processor 1010 may calculate an estimated arrival time at which the vehicle reaches one point on the predicted driving route based on the speed of the vehicle, and may control the vehicle the internal environment of the vehicle to be adjusted based on the estimated arrival time and the environment information about the point.

Meanwhile, the memory 1020 may store the external environment information of the vehicle, the condition of the passenger, and the adjusted internal environment information of the vehicle. In addition, according to another embodiment, the memory 1020 further may store a mapping table in which the condition of the passenger, the external environment information of the vehicle, and contents on the adjustment of the internal environment of the vehicle are mapped. In this case, in a case where new driving is started, the processor 1010 may control the vehicle to allow the internal environment of the vehicle to be adjusted, based on the external environment information of the vehicle received during the new driving and data corresponding to the inferred condition of the passenger during the new driving, on the mapping table stored in the memory 1020.

It is obvious to those skilled in the art that features and functions of the processor 1010 and the memory 1020 may correspond to the processor 180 and the memory 170 in FIG. 1.

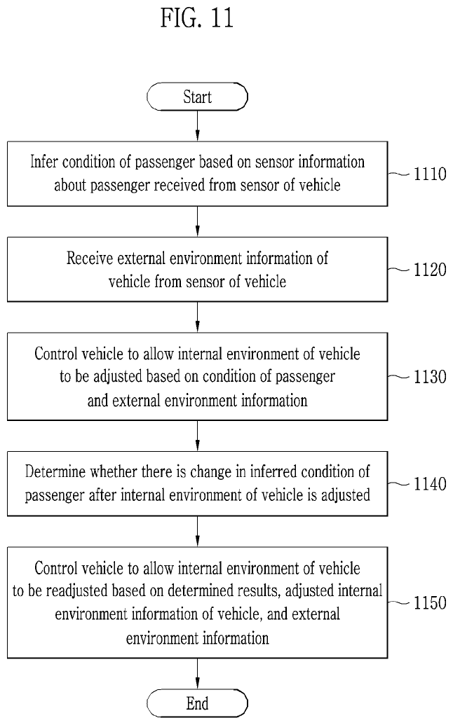

FIG. 11 is a flowchart of a method of adjusting the internal environment of a vehicle, according to an embodiment of the present invention.

In step 1110, the autonomous driving apparatus may infer a condition of a passenger based on sensor information about the passenger received from a sensor of a vehicle. Here, the inferred condition of the passenger is defined as an abnormal manifestation appearing on a passenger when the passenger is uncomfortable as much as the adjustment of the internal environment of the vehicle is needed.

In step 1120, the autonomous driving apparatus may receive the external environment information of the vehicle from the sensor of the vehicle. Here, the external environment of the vehicle 400 may be defined as an environment including night and day, weather, a type of the road (a tunnel, an urban road, a coastal road, and the like) on which the vehicle is currently driving, a degree of congestion on the road where the vehicle is driving, a temperature, humidity, a degree of fine dust, and the like. However, the external environment of the vehicle which the autonomous driving apparatus may consider is not limited thereto.

In step 1130, the autonomous driving apparatus may control the vehicle to allow the internal environment of the vehicle to be adjusted based on the condition of the passenger and the external environment information. At this time, the autonomous driving apparatus may control the vehicle to allow the internal environment of the vehicle to be adjusted, based on a signal input by the passenger.

In step 1140, the autonomous driving apparatus may determine whether there is a change in the inferred condition of the passenger after the internal environment of the vehicle is adjusted.

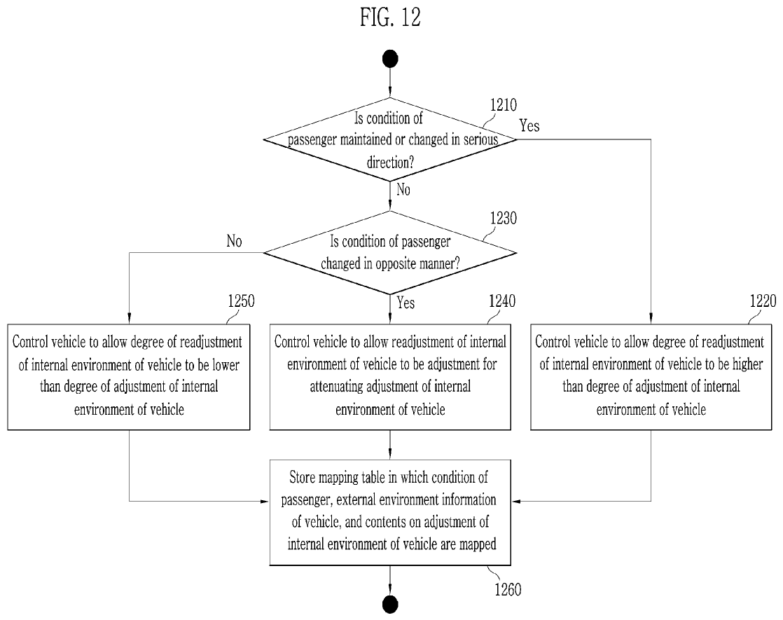

In step 1150, the autonomous driving apparatus may control the vehicle to allow the internal environment of the vehicle to be readjusted based on the determined results, the adjusted internal environment information of the vehicle, and the external environment information. Specifically, a method of readjusting the internal environment of the vehicle according to a change in the inferred condition of the passenger will be described in detail with reference to FIG. 12.

FIG. 12 is a flowchart of a method of adjusting an internal environment of a vehicle, according to another embodiment of the present invention.

The method of adjusting the internal environment of the vehicle described in FIG. 12 includes another example related to steps 1140 and 1150 in FIG. 11.

In step 1210, the autonomous driving apparatus may determine whether the condition of the passenger is maintained or changed in a serious direction as compared to the condition before the adjustment of the internal environment of the vehicle. In a case where it is determined that the condition of the passenger is maintained, or changed in a serious direction, step 1220 may be performed, and otherwise, step 1230 may be performed.

In step 1220, the autonomous driving apparatus may control the vehicle to allow a degree of readjustment of the internal environment of the vehicle to be higher than a degree of the adjustment of the internal environment of the vehicle. For example, even though the air conditioner is operated to allow the internal temperature of the vehicle to increase based on the condition of the passenger inferred by the autonomous driving apparatus, the autonomous driving apparatus may control the vehicle to allow the set temperature of the air conditioner to be lowered, in a case where it is inferred that the passenger is still sweating.

In step 1230, the autonomous driving apparatus may determine whether the condition of the passenger is changed in a manner opposite to the condition before the adjustment of the internal environment of the vehicle. In a case where it is determined that the condition of the passenger is changed in the opposite manner, step 1240 may be performed, and otherwise, step 1250 may be performed.

In step 1240, the autonomous driving apparatus may control the vehicle to allow the readjustment of the internal environment of the vehicle to be an adjustment for attenuating the adjustment of the internal environment of the vehicle. For example, in a case where it is inferred that the passenger is shaking after the air conditioner is operated to allow the internal temperature of the vehicle to increase based on the condition of the passenger inferred by the autonomous driving apparatus, the autonomous driving apparatus may control the vehicle to allow the operation of the air conditioner of the vehicle to be stopped or the set temperature to be higher.

In step 1250, the autonomous driving apparatus may control the vehicle to allow the degree of the readjustment of the internal environment of the vehicle to be lower than the degree of the adjustment of the internal environment of the vehicle. For example, in a case where, after it is inferred that the passenger waves a hand, the air conditioner is operated to allow the internal temperature of the vehicle to increase, the passenger will stop a gesture of waving a hand. In this case, the autonomous driving apparatus may control the vehicle to increase the set temperature of the air conditioner.

In step 1260, the autonomous driving apparatus may store a mapping table in which the condition of the passenger, the external environment information of the vehicle, and the contents on the adjustment of the internal environment of the vehicle are mapped. In addition, since the autonomous driving apparatus stores a mapping table for respective passengers and adjusts the internal environment by utilizing the mapping table, it is possible to provide personalized internal environments for respective passengers of the vehicle.

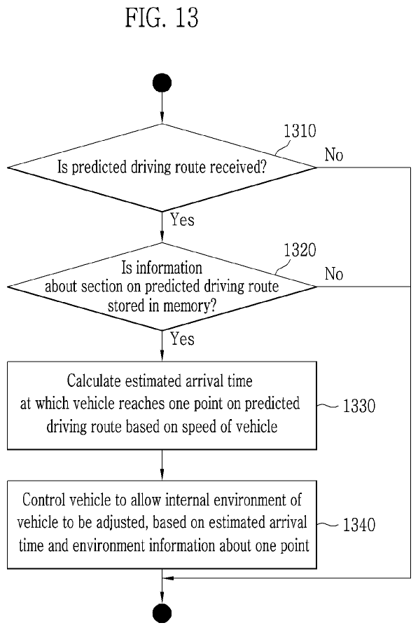

FIG. 13 is a flowchart of a method of adjusting the internal environment of a vehicle, according to another embodiment of the present invention.

The method of adjusting the internal environment of the vehicle described in FIG. 13 includes another example related to step 1130 of FIG. 11.

In step 1310, the autonomous driving apparatus determines whether the predicted driving route may be received. In a case where the predicted driving route may be received, step 1320 may be performed.

In step 1320, the autonomous driving apparatus may determine whether information about one section on the predicted driving route is stored in the memory. In a case where information about one section is stored, step 1330 may be performed. Here, the memory may be a component included in the autonomous driving apparatus, but the memory may be located at any position as long as the autonomous driving apparatus has access to information about one section.

In step 1330, the autonomous driving apparatus may calculate an estimated arrival time at which the vehicle reaches one point on the predicted driving route based on the speed of the vehicle. Here, one point on the predicted driving route may be any point included in one section.

In step 1340, the autonomous driving apparatus may control the vehicle to allow the internal environment of the vehicle to be adjusted, based on the estimated arrival time and the environment information about the one point. Specifically, in a case where the predicted driving route of the vehicle includes a driving route having a history in which the vehicle has been previously driven along the driving route, and information of the driving route along which the vehicle has been previously driven is stored in a memory, the autonomous driving apparatus may infer the internal environment of the vehicle when the vehicle reaches one point on the predicted driving route based on the information of the driving route, and control the vehicle based on the inferred internal environment.

Although the exemplary embodiments of the present disclosure have been described in this specification with reference to the accompanying drawings and specific terms have been used, these terms are used in a general sense only for an easy description of the technical content of the present disclosure and a better understanding of the present disclosure, and are not intended to limit the scope of the present disclosure. It will be clear to those skilled in the art that, in addition to the embodiments disclosed here, other modifications based on the technical idea of the present disclosure may be implemented.

From the foregoing, it will be appreciated that various embodiments of the present disclosure have been described herein for purposes of illustration, and that various modifications may be made without departing from the scope and spirit of the present disclosure. Accordingly, the various embodiments disclosed herein are not intended to be limiting, with the true scope and spirit being indicated by the following claims.

What is claimed is:

1. An autonomous driving method comprising:
inferring a condition of a passenger based on sensor information about the passenger received from a sensor of the vehicle;
receiving external environment information of the vehicle from the sensor of the vehicle;
controlling the vehicle to allow the internal environment of the vehicle to be adjusted, based on the condition of the passenger and the external environment information;
determining whether there is a change in the inferred condition of the passenger, after the internal environment of the vehicle is adjusted; and
controlling the vehicle to allow the internal environment of the vehicle to be readjusted, based on the determined results, the adjusted internal environment information of the vehicle, and the external environment information.

2. The method of claim 1, wherein, in a case where, after the internal environment of the vehicle is adjusted, it is determined that the inferred condition of the passenger is changed in a relaxed direction from a condition before the adjustment of the internal environment of the vehicle, a degree of the readjustment of the internal environment of the vehicle is lower than a degree of the adjustment of the internal environment of the vehicle.

3. The method of claim 1, wherein, in a case where, after the internal environment of the vehicle is adjusted, it is determined that the inferred condition of the passenger is changed in a manner opposite to a condition before the adjustment of the internal environment of the vehicle, the readjustment of the internal environment of the vehicle is an adjustment for attenuating the adjustment of the internal environment of the vehicle.

4. The method of claim 1, wherein, in a case where, after the internal environment of the vehicle is adjusted, it is determined that the inferred condition of the passenger is maintained in a condition before the adjustment of the internal environment of the vehicle or changed in a serious direction, a degree of the readjustment of the internal environment of the vehicle is higher than a degree of the adjustment of the internal environment of the vehicle.

5. The method of claim 1, wherein controlling the vehicle to allow an internal environment of the vehicle to be adjusted, indicates controlling the vehicle to allow an internal environment of the vehicle to be adjusted, based on a signal input by the passenger.

6. The method of claim 1, further comprising: storing a mapping table in which a condition of the passenger, external environment information of the vehicle, and contents on the adjustment of the internal environment of the vehicle are mapped.

7. The method of claim 6, further comprising: controlling the vehicle to allow the internal environment of the vehicle to be adjusted, based on the external environment information of the vehicle received during new driving and data corresponding to the inferred condition of the passenger during new driving, on the mapping table, in a case where the new driving is started.

8. The method of claim 1, wherein controlling the vehicle to allow the internal environment of the vehicle to be readjusted indicates controlling the vehicle to allow the internal environment of the vehicle to be readjusted, based on at least one of a predicted driving route of the vehicle and a speed of the vehicle.

9. The method of claim 8, further comprising: calculating an estimated arrival time at which the vehicle reaches one point on the predicted driving route, based on the speed of the vehicle, wherein controlling the vehicle to allow an internal environment of the vehicle to be adjusted indicates controlling the vehicle to allow an internal environment of the vehicle to be adjusted based on the estimated arrival time and environment information about the one point.

10. The method of claim 1, wherein controlling the vehicle to allow the internal environment of the vehicle to be adjusted indicates outputting at least one of the condition of the passenger, the external environment information, and contents on the adjustment of the internal environment of the vehicle.

11. An autonomous driving apparatus comprising: a processor configured to infer a condition of a passenger based on sensor information about the passenger received from a sensor of the vehicle, to receive external environment information of the vehicle from the sensor of the vehicle, to control the vehicle to allow the internal environment of the vehicle to be adjusted, based on the condition of the passenger and the external environment information, to determine whether there is a change in the inferred condition of the passenger after the internal environment of the vehicle is adjusted, and to control the vehicle to allow the internal environment of the vehicle to be readjusted based on the determined results, the adjusted internal environment information of the vehicle, and the external environment information; and a memory configured to store the external environment information of the vehicle, the condition of the passenger, and the adjusted internal environment information of the vehicle.

12. The apparatus of claim 11, wherein, in a case where, after the internal environment of the vehicle is adjusted, it is determined that the inferred condition of the passenger is changed in a relaxed direction from a condition before the adjustment of the internal environment of the vehicle, the processor is configured to control the vehicle to allow a degree of the readjustment of the internal environment of the vehicle to be lower than a degree of the adjustment of the internal environment of the vehicle.

13. The apparatus of claim 11, wherein, in a case where, after the internal environment of the vehicle is adjusted, it is determined that the inferred condition of the passenger is changed in a manner opposite to a condition before the adjustment of the internal environment of the vehicle, the processor is configured to control the vehicle to allow the readjustment of the internal environment of the vehicle to be an adjustment for attenuating the adjustment of the internal environment of the vehicle.

14. The apparatus of claim 11, wherein, in a case where it is determined that the inferred condition of the passenger is maintained in a condition before the adjustment of the internal environment of the vehicle or changed in a serious direction, the processor is configured to control the vehicle to allow a degree of the readjustment of the internal environment of the vehicle to be higher than a degree of the adjustment of the internal environment of the vehicle.

15. The apparatus of claim 11, wherein the processor is configured to control the vehicle to allow the internal environment of the vehicle to be adjusted, based on a signal input by the passenger.

16. The apparatus of claim 11, wherein the memory stores the mapping table stores the condition of the passenger, the external environment information of the vehicle, and contents on the adjustment of the internal environment of the vehicle are mapped.

17. The apparatus of claim 16, the processor is configured to control the vehicle to allow the internal environment of the vehicle to be adjusted, based on the external environment information of the vehicle received during the new driving and data corresponding to the inferred condition of the passenger during the new driving, on the mapping table.

18. The apparatus of claim 11, wherein the processor is configured to control the vehicle to allow the internal environment of the vehicle to be readjusted, based on at least one of a predicted driving route of the vehicle and a speed of the vehicle.

19. The apparatus of claim 18, wherein the processor is configured to calculate an estimated arrival time at which the vehicle reaches one point on the predicted driving route, based on the speed of the vehicle, and to control the vehicle to allow the internal environment of the vehicle to be adjusted, based on the estimated arrival time and the environment information about the one point.

20. A computer-readable recording medium that records a method for executing the method of claim 1 on a computer.
